(19) United States
(12) Patent Application Publication
(10) Pub. No.: US 2014/0344157 A1
(43) Pub. Date: Nov. 20, 2014

(54) Method and device for carrying out cashless payment

(71) Applicant: Secure Payment Technologies GmbH, Innsbruck (AT)

(72) Inventor: Michael Suitner, Innsbruck (AT)

(21) Appl. No.: 14/356,946

(22) PCT Filed: Nov. 8, 2012
(86) PCT No.: PCT/AT2012/000285

§ 371 Date: May 8, 2014

(30) Foreign Application Priority Data
Nov. 8, 2011 (AT) A 1649/2011

(51) Int. Cl. G06Q 20/32; G06Q 20/38; G06Q 20/10; G06Q 20/40; G06Q 20/26

(52) U.S. Cl. CPC G06Q 20/322; G06Q 20/4012; G06Q 20/26; G06Q 20/10; G06Q 20/385
USPC 705/44

(57) ABSTRACT

In a method for carrying out cashless payments by means of mobile telecommunications terminals and at least one electronic payment processing center, wherein each telecommunications terminal has stored a subscriber identifier and the payment processing center has stored the subscriber identifiers of the participating telecommunication terminals and payment limits each assigned to the respective subscriber identifiers, the payment transaction is performed based on a transaction code generated by the payment processing center and transmitted to the mobile telecommunications terminal, from there to the cash register system of the payment recipient, and from there to the payment processing center along with the payment amount, where the transaction code is verified and the payment amount is matched with the respective payment limit.

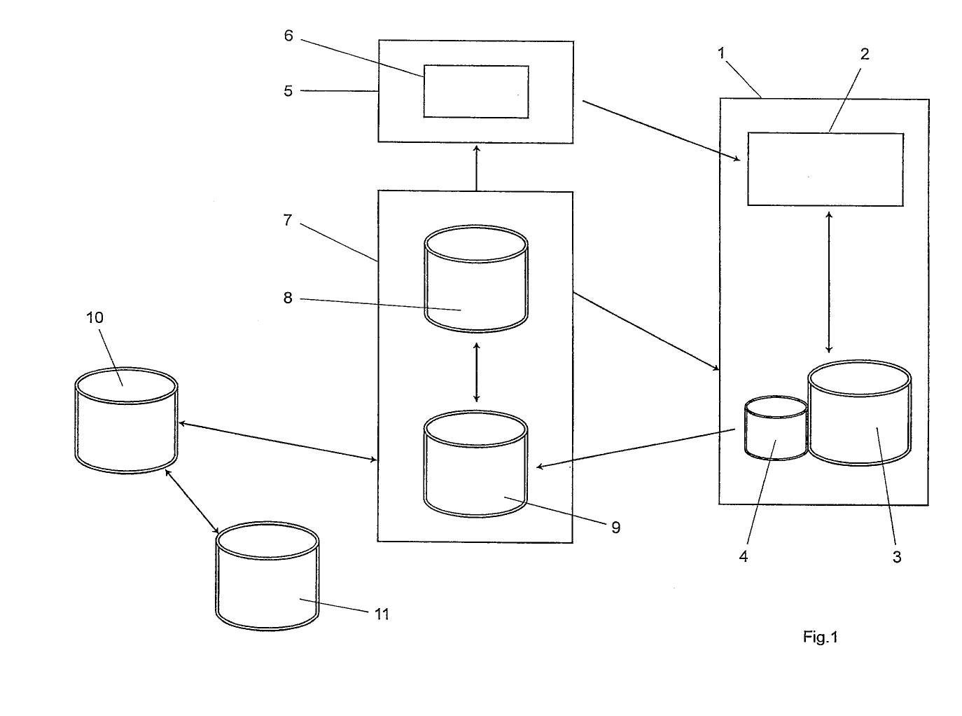

The invention relates to a method as well as to a device for carrying out cashless payments by means of mobile telecommunications terminals.

Typically, cashless payments are carried out via financial institutions and relate to payments in the form of book money between bank giro accounts, in the case of which no cash is moved. The account of the remitter is debited with the payment amount, and the receiver receives a corresponding credit in his account. The financial institutions provide the service of making the transfer and, for the most part, receive a credit for fees, possibly in the context of flat fees for managing the account.

The order for carrying out a cashless payment can either be placed by the payment recipient or by the payer. In response to the placement of an order by the payer, the latter carries out a transfer, for example by means of electronic banking. For the most part, the placement of the order by the payment recipient is made by way of direct debiting based on a corresponding contractual relationship between payment recipient and payer. In addition to the classic transfer and the direct debiting, a plurality of electronic payment options exists, such as, for example, cash cards, debit cards and credit cards. On principle, the card payments use one of the above-mentioned basic payment methods. For the most part, the amounts are collected from the card owner via guaranteed non-refundable debits and his account is debited. In addition to the function of the cards as cashless payment means, they mainly serve to raise cash and, in the case of the credit card, to take advantage of short-term credit.

Even though the mentioned electronic payment options are associated with the advantage of a quick and easy payment as well as with high degree of safety due to the fact that only small amounts of cash are kept, there are a number of disadvantages. The online authorization of the used card, which is required in most cases in the course of a payment transaction, for example, involves considerable expenses. The online authorization requires a direct data connection of the cash register system of the payment recipient to the computer center of the institution or of the bank, respectively, which issued the card. The online authorization delays the payment transaction and causes data transfer costs. The payment transaction is furthermore delayed even further by additional controls, such as entering a PIN, for example, so that user-friendliness and efficiency are low. In the case of the common payment methods, it is furthermore disadvantageous that a number of personal data of the payer is disclosed, so that there is a risk of misuse. In the case of common electronic payment options, the payment recipient knows the name of the card owner, his card number as well as the PIN code, for example. In the course of carrying out a transaction, further data are added, such as, for example, the purchased article as well as the account number of the payer. Together with the above-mentioned personal data, a clear assignability of different security-relevant and confidential data to individual persons is thus at hand, so that the risk of misuse of the data is high.

A common payment transaction using an electronic payment card typically runs as follows:
1) Amount is entered.
2) Card is demanded and is read out by means of the card reader. The safety module is activated and demands the entering of the personal identification number.
3) The communication module establishes a connection to the provider and logs in there for data exchange.
4) Plausibility checks are carried out by data exchange via the communication connection.
5) Via online connection to the bank, it is checked whether a) no entry of the used card is present in the blacklist; b) the personal identification number, which was entered, is correct; c) the payment amount lies within the available limit. Payment is declined, if one of the conditions is not fulfilled.
6) The communication module logs off from the provider and terminates the connection. Some terminals remain always online.
7) The printer establishes a protocol relating to payment or rejection. The display displays the corresponding information.
8) The result “payment made” guarantees the merchant that he will be paid.

The present invention aims to improve a method and a device of the above-mentioned type such that the effort for the authorization and the risk for a data misuse are reduced. The cashless payment is to be made possible in a simple manner by means of mobile telecommunications terminals, without having to accept losses with reference to the security of the payment transaction.

Mobile telecommunication terminals, in particular, are especially jeopardized from a safety viewpoint, because they can be more easily stolen and do not comprise any sophisticated protection technologies (firewall etc.).

To solve this object, provision is made according to a first aspect of the invention for a method for carrying out cashless payments by means of mobile telecommunications terminals and at least one electronic payment processing center, wherein each telecommunications terminal has stored a subscriber identifier and the payment processing center has stored the subscriber identifiers of the participating telecommunication terminals and payment limits each assigned to the respective subscriber identifiers, which method comprises the steps of:
a) generating a transaction code specific to the payment transaction using an algorithm,
b) storing the transaction code and assigning the transaction code to a subscriber identifier and the payment limit assigned thereto,
c) transmitting the transaction code to a mobile telecommunications terminal,
d) transmitting the transaction code from the mobile telecommunications terminal to a cash register system of the payment recipient in the context of a cashless payment transaction,
e) transmitting a data set from the cash register system to the payment processing center, said data set at least including the transaction code and the desired payment amount,
f) authorizing the transaction code in the payment processing center,
g) ascertaining the payment limit assigned to the transaction code,
h) releasing the payment, if the desired payment amount lies within the assigned payment limit,
i) storing the released payment in the payment processing center to subsequently or immediately initiate a debiting order.

In the context of the invention, the authorizing of the payment thus primarily takes place in the payment processing center. The authorizing of the transaction code preferably comprises the matching of the transaction code transmitted from the cash register system to the payment processing center with the transaction codes stored in step b).

The authorization of the payment in the cash register system is only performed at a failure of the data connection between the cash register system and the payment processing center. In that case, a permanent online connection to a bank is no longer necessary. If the transmission of the data set according to step e) fails, it is preferably proceeded in the following manner: the desired payment amount is compared to a general payment limit stored in the cash register system, the payment is released if the desired payment amount lies within the general payment limit and the transaction code is valid, and the released payment is stored in the cash register system to be subsequently or immediately passed to the payment processing center in order to initiate a debiting order. The authorizing of the transaction code in that case preferably comprises the verification of the validity of the transaction code in the cash register system using a check algorithm stored in the cash register system, in order to determine whether the transaction code was generated by the payment processing center.

Due to the fact that the general payment limit is verified per transaction code in the cash register system or in a program add-on of the cash register system, the general payment limit of the payment solution is available to the payment recipient without requiring any further inquiry or control concerning this matter at the card-issuing institution or the bank.

If the bank network changes the payment limit of an account that is connected to a telecommunications terminal, this is preferably immediately notified to the payment processing center. Based on this notification, the payment processing center changes the payment limit of the transaction code already delivered to the telecommunications terminal, of the respective payer in the database.

It is thereby ensured that already circulating transaction codes can also be provided with new limits at any time. Since the authorization of the payment is preferably performed in the payment processing center, the latter knowing the latest payment limit of each payer, it will be ensured that only the latest payment limits will be applied in the context of the payment transaction without having to exchange the already delivered transaction codes.

To authenticate the mobile telecommunications terminal of the payer, the transaction code generated prior to carrying out the payment transaction and transmitted to the mobile telecommunications terminal of the payer is used. In a preferred mode of procedure, the transaction code can in advance be subjected to a validity check in the cash register system of the payment recipient, or in a program add-on of the cash register system, using a stored check algorithm, wherein transfer to the payment processing center will only be performed if the validity check has been positive. The validity check thus only requires the check algorithm stored in the cash register system, said check algorithm being renewable at regular intervals in order to increase the security.

The identification of the payer is exclusively based on the transaction code transmitted in the context of the payment transaction. In the context of the payment transaction, no personal data are available to the payment recipient, so that the highest possible data protection will be reached, in particular where the transaction code is neither the number of a credit, debit or cash card nor the number of a bank account. If, moreover, no relationship exists between the transaction code and a telephone number of the mobile telecommunications terminal, no assignment to a certain person will thus be possible either.

If the authorization or release of the payment is effected in the periphery of the cash register system in case of a failure of the data connection between the cash register system and the payment processing center, a plurality of payments can be gathered in the cash register system before the payments are passed on for actually carrying out the transfer or for initiating direct debiting.

In most cases, there will be a data connection between the cash register system and the payment processing center. In such cases, the payments will be immediately passed on to the payment processing center.

As soon as the payment has been released in the payment processing center, the transfer of the payment amount will be effected, wherein it is preferably provided that the transfer from an account of the subscriber (buyer) directly takes place to an account of the payment recipient. Overall, just a single transfer is thus performed to transfer the amount from the buyer to the seller. An intermediate center, e.g. at a separate provider at which a credit account must initially be filled up by transfer from the bank account or indication of a credit card number and from which the transfer to the final payment recipient takes place, is not required.

A preferred mode of procedure in this context provides that the initiation of the debiting order comprises the following steps:
ascertaining the subscriber identifier assigned to the transaction code transmitted from the cash register system to the payment processing center in the payment processing center, and
transmitting the subscriber identifier and the payment amount from the payment processing center to a banking network in the context of a debiting order, wherein personal account numbers and subscriber identifiers are stored, assigned to one another, in the banking network or an interface between the banking network and the payment processing center, and the subscriber identifier transmitted by the payment processing center is assigned to the corresponding account number, and an account is debited using the account number, the respective credit entry in the account of the payment recipient being preferably performed immediately.

In this respect, it is essential that in terms of data protection the payment processing center also does not possess any personal data. The payment processing center only has data sets provided by the cash register system and including at least the transaction code and the payment amount. In principle, the data set also includes further data, which provide for the payment transaction, such as, for example, an identification of the payment recipient and the like. The payment processing center subsequently transmits the data set to a banking network, either directly or indirectly, wherein the assignment of the subscriber identifier to an account number is made only at that location. This means that the assignment of the payment to a certain person can only be made at the bank. To further increase the security, it is preferably provided that the personal account number is a virtual account number, wherein virtual account numbers and real account numbers are stored in the banking network assigned to one another and the virtual account number is assigned to the corresponding real account number in the context of a debiting order. The subscriber identifier is thus not translated directly into a real account number of the payer, but a virtual account number is added in-between, so that the actual personal account number of the payer is also not available in the interface, which might be used, between the banking network and the payment processing center. Instead, the translation of the subscriber identifier into a virtual account number takes place in said interface, so that, even in the event that the payment processing center were to inadmissibly obtain access to the data sets of the interface, usable personal data cannot be acquired. A translation of the virtual account number into the real account number takes place only after the transmission of the payment data sets to the bank, so that an assignment of the payment to a specific person actually only becomes possible at the bank itself.

The data transfer between the mobile telecommunications terminal and the cash register system can take place using common data transfer standards, for which the plurality of the telecommunications terminals is equipped. For example, modern mobile telephones have the option of a Bluetooth, WLAN or NFC connection. However, this requires a corresponding retrofitting of existing cash register systems, so as to attain the respective required hardware-related adaptation and to implement the respective transfer protocols with regard to software. To reduce the respective effort and to simultaneously realize a data transfer, which is as safe as possible and which does not require any additional equipment, it is preferably provided that the code is an optoelectronically readable code, in particular a bar code, which is displayed on a display unit of the mobile telecommunications terminal. Such an optoelectronically readable code, in particular a bar code, can be read on the display unit of the telecommunications terminal by means of common and widespread bar code scanners. However, the system according to the invention can also be readily used by means of NFC technology or any other communications technology on POS (point of sale).

In the context of the method according to the invention, checking the validity of the data provided by the payer is mainly based on the transmitted transaction code. The transaction code is generated using an algorithm and, in the event of a temporary non-accessibility of the payment processing center, is checked in the cash register system by a check algorithm as to whether the transaction code a) was generated by the payment processing center and b) lies within the general payment limit for transaction codes. A particularly preferred embodiment will result if the check algorithm and the algorithm used for generating the transaction code are tuned to each other. This means that the check algorithm and the algorithm, which is used for generating the transaction code, must be mathematically linked with one another such that the check algorithm only considers those transactions to be valid, which were generated using the algorithm, which was provided for generating the transaction code. To increase security, provision is hereby preferably made for the algorithm, which is used for generating the transaction code, to be stored in the payment processing center. The algorithm, which is used for generating the transaction code, thus lies outside of the sphere of influence of the payer, so that manipulation is made more difficult. Provision is preferably further made for the transaction code to be generated in the payment processing center.

It is conceivable that the respective payment limit is provided by the payer at every payment transaction, so that the effort for the corresponding verification on the part of the payment recipient is dispensed with. In the simplest case, the payer can determine the payment limit himself, which can be made by setting a corresponding standard value in the mobile telecommunications terminal, for example. However, setting the payment limit can also be carried out separately for each payment. Setting the payment limit by the payer, however, has the disadvantage that the corresponding account coverage is not guaranteed. Provision is thus preferably made for the payment limits to be managed centrally. Provision is hereby preferably made for the subscriber identifiers to be stored in the payment processing center and for a respective payment limit to be assigned to each subscriber identifier. It is particularly preferred when the payment limit assigned to a subscriber identifier in the payment processing center is matched with a stored payment limit assigned to the respective subscriber identifier in a banking network.

In order to ensure that the current payment limit is each available for a payment transaction, the approach in the context of the invention can be such that a payment limit set to zero after a matching procedure is passed on to the mobile telecommunications terminal corresponding to the subscriber identifier such that the telecommunications terminal will not receive a new transaction code and the already existing transaction code will be deleted from the program application.

To further increase the security, it is preferably provided that the application loads the transaction code from a storage prior to transmitting it to the cash register system and generates a time stamp during the loading of the transaction code, which time stamp is transmitted to the payment processing center and stored in a manner assigned to the transaction code, and that authorizing the transaction code in the payment processing center according to step f) comprises comparing the time stamp to the current time, wherein releasing the payment according to step h) is performed under the additional condition that the difference between the current time and the time stamp does not exceed a defined value. When opening a transaction code in the program application, a time stamp is thus additionally generated and notified to the payment processing center. This time stamp is stored in the database. Transaction codes have defined periods of validity. Using the time stamp, the payment processing center may refuse transaction codes that have exceeded such periods of validity.

The functions required for carrying out the cashless payment transaction are designed such that they can easily be realized on common mobile telephones. A particularly comfortable and user-friendly embodiment hereby provides for the method steps, which can be executed on the mobile telecommunications terminal, to be implemented in a program application, which can be downloaded to the device. Such a program application can provide for a corresponding user-friendly and appealing user surface at the same time. The function of encoding the data, which are to be transmitted, can also be implemented in the program application, wherein a corresponding large-surface display element also provides for the display of a bar code, which is preferably provided. The subscriber identifier can furthermore be embedded in the program application in a simple manner, wherein it is preferably provided in this context that the subscriber identifier is an application-specific identifier, which is, for instance, generated by the banking network and stored in the program application. To increase the security, it may preferably be further provided that the application starts a PIN request prior to transmitting the transaction code from the mobile telecommunications terminal to the cash register system, and the transmission only takes place at a correct PIN entry. In detail, the procedure can, for instance, be provided as follows:
a) The application receives the transaction code at a time at which the mobile telephone is online—possibly already long before the application is activated for payment.
b) When the PIN is entered into the application, it is preferably checked again whether the code already held ready in the application complies with the payment limit. If the payment limit has meanwhile been set to zero, the application will not receive a new transaction code and the transaction code available on the application will be deleted. In this case, the application can no longer be used for payment.
c) If the payment limit is out-dated, the old transaction code will be replaced by a new one.
d) If no online connection is available at the time of the PIN entry, the already held transaction code will be used.

Unlike stationary computers or notebooks, mobile telephones are relatively easy to steal and usually do not have security means such as firewalls. A mobile phone is thus an easier target for hackers and provides easier readability of its stored content, e.g. sensitive data. In order to ensure that the program application on the mobile phone will not be manipulated, copied or misused, it is provided in a preferred manner that, when generating a transaction code according to step a), a check code is generated and stored assigned to the transaction code, that, when transmitting the transaction code to the mobile telecommunications terminal according to step c), the check code is simultaneously transmitted, that, with the request for a new transaction code by the mobile telecommunications terminal to the payment processing center, the check code is retransmitted to the payment processing center, that the check code in the payment processing center is compared to the check code stored there, and that the transmission of the new transaction code to the mobile telecommunications terminal is released if the retransmitted check code matches the stored check code. The check code advantageously is a 72-digit hexadecimal value which is generated in the payment processing center and stored in a safe element on the mobile telecommunications terminal. The check code constitutes an identification parameter of the program application for the payment processing center, which changes at each inquiry, proves the operability of the program application and attests the integrity of the program application (not manipulated, not hacked, program application was not transferred to another mobile phone).

In order to ensure that the program application will also function if the mobile telecommunications terminal has no data connection, the program application is able to store more than one transaction code in a safe element on the mobile phone. The stored transaction codes are called up by the program application according to the principle “first in-first out”. When the mobile phone is again able to build up a data connection, the “transaction code-store” on the mobile phone is again filled up. In this context, the method according to the invention is preferably carried out such that in steps a), b) and c) at least two transaction codes are each generated, transmitted and stored in the mobile communications terminal.

According to a second aspect of the invention, a device for carrying out cashless payments by means of mobile telecommunications terminals is proposed, comprising an electronic payment processing center and at least one electronic cash register system of a payment recipient, wherein the payment processing center comprises at least one database, which stores subscriber identifiers of mobile telecommunications terminals and payment limits assigned to the subscriber identifiers, a transaction code generator, which generates a transaction code specific to the respective payment transaction using an algorithm, and transmission means for transmitting the transaction code to the mobile telecommunications terminal, and wherein the cash register system is configured to receive the transaction code transmitted by a mobile telecommunications terminal in the context of a cashless payment transaction, wherein the cash register system comprises input means for entering a payment amount, wherein the cash register system further comprises transmission means for transmitting a data set including the transaction code and the payment amount to the payment processing center, wherein the payment processing center comprises processing means that are configured to authorize the received transaction code and to ascertain the payment limit assigned to the transaction code, wherein the payment processing center further comprises release means for releasing the payment, provided the following conditions are fulfilled: the desired payment amount lies within the payment limit and the transaction code is valid, wherein the payment processing center further comprises a storage for storing the released payment, wherein the storage cooperates with transmission means to pass on the payment either later or immediately for initiating a debiting order.

Preferred further developments of the devices according to the invention are defined in the subclaims.

The invention will be explained in more detail below by means of an exemplary embodiment, which is illustrated schematically in the drawing. 1 identifies a cash register system of a payment recipient, which comprises at least one cash register 2, which is connected to a central cash register server 3. The cash register server 3 can hereby be located locally on the location of the cash register 2. In particular in the case of cash register systems comprising a plurality of spatially distributed cash registers 2, the cash register server 3 can also be arranged at a remote location. The cash register server 3 is a common accounting system, to which data relating to the payments processed by the individual cash registers 2 are transmitted. Typically, the payment amount, an identification of the cash register 2 as well as the time of payment is thereby transmitted for each payment. The cash registers are thereby suitable to process cash payments as well as electronic cashless payments. The connection of the individual cash registers 2 to the cash register server 3 takes place via common protocols, such as via an XML web service, for example.

In the present exemplary embodiment, the common cash register server 3 is supplemented with a program add-on 4, which allows for the implementation of the instant invention.

A mobile telecommunications terminal of a user is identified with 5. This is a common mobile telephone, wherein smart phones are suitable in particular. A program application 6 that allows for the processing of the cashless payment method according to the invention is installed on the mobile telecommunications terminal 5.

The central payment processing center is denoted by 7 and comprises a payment server 8 as well as a database 9. The payment processing center 7 can establish a data connection to the cash register system 1 as well as to the mobile telecommunications terminal 5.

The payment processing center 7 is furthermore connected to an exchange server 10, which, in turn, is in contact with a bank 11 or corresponding electronic banking networks.

From the point of view of a customer who wants to process a cashless payment, the processing of a cashless payment according to the present invention runs as follows. It is assumed hereby that the customer has an account at a bank. Initially, the bank customer must load the program application 6 to his mobile telecommunications terminal 5. Preferably, this takes place such that the bank customer signs into the online banking area of his bank and links the program application 6 to his bank account at that location. As soon as the customer has loaded the program application 6 to his mobile telecommunications terminal 5 and has it installed thereon, the end device 5 is ready for cashless payment transactions. Prior to this, a subscriber identifier generated by the bank 11 was stored in the program application 6. The storing process can either take place by means of manually entering the subscriber identifier by the customer or can already have been stored by the bank in the program application, which is provided for downloading. It is significant that the subscriber identifier is a clear and unique identifier, so that it is thus possible to clearly identify the subscriber based on the subscriber identifier.

When the customer wants to pay without cash in a store, he opens the program application 6 on his mobile telecommunications terminal 5 by a PIN request. The program application displays a unique bar code, which is read by a bar code reader of the cash register 2 on the display unit of the mobile telecommunications terminal 5. The transaction code transmitted in this manner is sent from the cash register system 3 to the payment processing center 7 and checked there. In the event that the payment processing center 7 cannot be reached, the transaction code is checked for validity in the program add-on 4. If the check is positive, the bar code will be accepted as payment and the payment amount will subsequently be withdrawn from the customer's bank account.

In order to enable the above-described cashless payment transaction, the technical implementation is provided as follows. The bank 11 is connected to the payment processing center 7 via the exchange server 10. When a bank customer downloads the program application 6, the bank 11 notifies the payment processing center 7 accordingly. The bank 11 hereby initially transmits the subscriber identifier assigned to the bank customer, together with an anonymous virtual account number, to the exchange server 10. The virtual account number is not the real account number of the bank giro account the subscriber keeps with the bank 11. The subscriber identifier and the virtual account number respectively assigned to the subscriber identifier are stored in the exchange server 10. The payment processing center 7 subsequently receives only the subscriber identifier. As a result, the payment processing center 7 does not have any real account numbers of the bank customer, so that, on principle, the data, which are available in the payment processing center 7, are anonymous, which has the result that the security standard in the payment processing center 7 as well as in the cash register system 1 can be chosen so as to be lower and that a possible data theft does not render any usable or personal data. The further data exchange between the payment processing center 7 and the bank 11 takes place only via the virtual account number, i.e. via the exchange server 10.

The bank 11 sends the payment limit, which is assigned to the corresponding account, to the payment processing center 7 along with the subscriber identifier. Provided that the payment limit of a customer changes subsequently, the bank 11 can send a new payment limit to the payment processing center 7 via the interface server 10 at any time.

The payment processing center 7 stores the subscriber identifier and the respective assigned payment limit in the database 9.

These data are transmitted to the payment server 8, which comprises a transaction code generator, by which unique transaction codes to be used once can be generated using an algorithm stored in the payment server 8. To prepare a cashless payment transaction by the aid of the mobile telecommunications terminal 5, the payment server 8 generates a transaction code and stores the same in a manner assigned to a subscriber identifier and the respective payment limit. The payment server 8 then transmits the transaction code to program application 6 of the mobile telecommunications terminal 5 in the form of a bar code, while it is verified whether the subscriber identifier of the program application corresponds to the subscriber identifier that is stored in the payment server as assigned to the transaction code to be transmitted. The data transfer can either take place upon inquiry of the program application 6 or can be initiated by the payment server 8.

After this, the program application 6 indicates the transaction code in the form of a bar code on the display unit of the mobile telecommunications terminal 5. The cash register 2 scans the displayed bar code by means of a bar code scanner and transmits it to the cash register server 3 along with the desired payment amount. The program add-on 4 implemented in the cash register server 3 passes the transmitted transaction code and the payment amount to the payment processing center 7 for verification.

In the payment processing center 7, it is then verified whether the transaction code received from the cash register system corresponds to a transaction code stored in the payment server. If this is the case, the payment limit assigned to the transaction code stored in the payment server is identified, and it is verified whether the desired payment amount lies within the payment limit. When both verifications have been positively completed, the payment processing center 7 signalizes that the payment can be accepted.

In the event that the payment processing center cannot be reached from the cash register system, the program add-on 4 can check by way of a locally stored check algorithm whether the transmitted transaction code was generated by the payment processing center and whether the payment amount lies within the general payment limit. After a positive verification of the payment, the cash register system 3, or the program add-on 4, notifies the cash register 2 that the payment can be accepted. As soon as the data connection between the cash register system and the payment processing center is reestablished, the payment-relevant data of the released payments are passed to the payment processing center 7 to initiate debit orders. The cash register system 3 is connected to the payment server 8 so as to enable the check algorithm stored in the cash register system 3 to be changed at any time.

Provided that the payment has been released, the transaction code and, in addition, the payment amount and further payment-relevant data such as identifications of the cash register and the merchant are stored in the database 9. Upon reception of these data in the database 9, the generation of a new transaction code by the payment sever 8 and the transmission thereof to the program application 6 of the respective customer are released, so that a new cashless payment transaction can be initiated. The payment processing center 7 furthermore transmits a data set including the subscriber identifier, the payment amount and an identification of the merchant and, where applicable, also the time stamp, an invoice number and further payment-relevant data to the exchange server 10. The exchange server 10 can assign the subscriber identifier to a virtual account number and sends a debiting order as well as the transaction details to the bank 11 or to a corresponding banking network along with the virtual account number. At the bank 11, the actual account of the customer is assigned by means of the virtual account number and the corresponding payment amount is debited to the account.

1. A method for carrying out cashless payments by means of mobile telecommunications terminals and at least one electronic payment processing center, wherein each telecommunications terminal has stored a subscriber identifier and the payment processing center has stored the subscriber identifiers of the participating telecommunication terminals and payment limits each assigned to the respective subscriber identifiers, which method comprises the steps of:
a) generating a transaction code specific to the payment transaction using an algorithm,
b) storing the transaction code and assigning the transaction code to a subscriber identifier and the payment limit assigned thereto,
c) transmitting the transaction code to a mobile telecommunications terminal,
d) transmitting the transaction code from the mobile telecommunications terminal to a cash register system of a payment recipient in the context of a cashless payment transaction,
e) transmitting a data set from the cash register system to the payment processing center, said data set at least including the transaction code and a desired payment amount,
f) authorizing the transaction code in the payment processing center,
g) ascertaining a payment limit assigned to the transaction code,
h) releasing the payment, if the desired payment amount lies within the assigned payment limit,
i) storing the released payment in the payment processing center to subsequently or immediately initiate a debiting order.

2. A method according to claim 1, wherein the authorizing of the transaction code comprises matching of the transaction code transmitted from the cash register system to the payment processing center with the transaction codes stored in step b).

3. A method according to claim 1, wherein, if the transmission of the data set according to step e) fails, the authorizing of the transaction code according to step f) is performed in the cash register system, the desired payment amount is compared to a general payment limit stored in the cash register system, the payment is released if the desired payment amount lies within the general payment limit and the transaction code is valid, and the released payment is stored in the cash register system to be subsequently or immediately passed to the payment processing center in order to initiate a debiting order.

4. A method according to claim 3, wherein the authorizing of the transaction code comprises verification of the validity of the transaction code in the cash register system using a check algorithm stored in the cash register system, in order to determine whether the transaction code was generated by the payment processing center.

5. A method according to claim 1, wherein the initiation of the debiting order comprises the following steps:
ascertaining the subscriber identifier assigned to the transaction code transmitted from the cash register system to the payment processing center in the payment processing center, and
transmitting the subscriber identifier and the payment amount from the payment processing center to a banking network in the context of a debiting order, wherein personal account numbers and subscriber identifiers are stored, assigned to one another, in the banking network or an interface between the banking network and the payment processing center, and the subscriber identifier transmitted by the payment processing center is assigned to the corresponding personal account number, and an account is debited using the personal account number, the respective credit entry in the account of the payment recipient being preferably performed immediately.

6. A method according to claim 5, wherein the personal account number is a virtual account number, wherein virtual account numbers and real account numbers are stored in the banking network assigned to one another and the virtual account number is assigned to the corresponding real account number in the context of a debiting order.

7. A method according to claim 1, wherein the transaction code is an optoelectronically readable code, in particular a bar code, which is displayed on a display unit of the mobile telecommunications terminal.

8. A method according to claim 4, wherein the check algorithm and the algorithm used for generating the transaction code are tuned to each other.

9. A method according to claim 1, wherein the algorithm used for generating the transaction code is stored in the payment processing center.

10. A method according to claim 4, wherein the check algorithm is generated in the payment processing center and transmitted to the cash register system, in particular an add-on of the cash register system.

11. A method according to claim 1, wherein the transaction code is generated in the payment processing center.

12. A method according to claim 1, wherein the subscriber identifier is a device-specific identifier.

13. A method according to claim 1, wherein the payment limit assigned to a subscriber identifier in the payment processing center is matched with a stored payment limit assigned to the respective subscriber identifier in a banking network.

14. A method according to claim 1, wherein the method steps to be performed on the telecommunications terminal are implemented in a program application that can be downloaded to the device.

15. A method according to claim 14, wherein the subscriber identifier is an application-specific identifier, which is, for instance, generated by a banking network and stored in the program application.

16. A method according to claim 14, wherein the application starts a PIN request prior to transmitting the transaction code from the mobile telecommunications terminal to the cash register system, and the transmission only takes place at a correct PIN entry.

17. A method according to claim 14, wherein the application loads the transaction code from a storage prior to transmitting it to the cash register system and generates a time stamp during the loading of the transaction code, which time stamp is transmitted to the payment processing center and stored in a manner assigned to the transaction code, and wherein authorizing the transaction code in the payment processing center according to step f) comprises comparing the time stamp to a current time, wherein releasing the payment according to step h) is performed under the additional condition that the difference between the current time and the time stamp does not exceed a defined value.

18. A method according to claim 1, wherein when generating a transaction code according to step a), a check code is generated and stored assigned to the transaction code, and, when transmitting the transaction code to the mobile telecommunications terminal according to step c), the check code is simultaneously transmitted, and, with a request for a new transaction code by the mobile telecommunications terminal to the payment processing center, the check code is retransmitted to the payment processing center, and the check code in the payment processing center is compared to the check code stored there, and wherein the transmission of the new transaction code to the mobile telecommunications terminal is released if the retransmitted check code matches the stored check code.

19. A method according to claim 1 wherein in steps a), b) and c) at least two transaction codes are each generated, transmitted and stored in the mobile communications terminal.

20. A device for carrying out cashless payments by means of mobile telecommunications terminals (5), comprising an electronic payment processing center (7) and at least one electronic cash register system (1) of a payment recipient, wherein the payment processing center (7) comprises at least one database (9), which stores subscriber identifiers of mobile telecommunications terminals and payment limits assigned to the subscriber identifiers, a transaction code generator, which generates a transaction code specific to a respective payment transaction using an algorithm, and transmission means for transmitting the transaction code to the mobile telecommunications terminal (5), and wherein the cash register system (1) is configured to receive the transaction code transmitted by a mobile telecommunications terminal (5) in the context of a cashless payment transaction, wherein the cash register system (1) comprises input means for entering a payment amount, wherein the cash register system (1) further comprises transmission means for transmitting a data set including the transaction code and the payment amount to the payment processing center (7), wherein the payment processing center (7) comprises processing means that are configured to authorize the received transaction code and to ascertain a payment limit assigned to the transaction code, wherein the payment processing center further comprises release means for releasing the payment, provided the following conditions are fulfilled: the desired payment amount lies within the payment limit and the transaction code is valid, wherein the payment processing center (7) further comprises a storage for storing the released payment, wherein the storage cooperates with transmission means to pass on the payment either later or immediately for initiating a debiting order.

21. A device according to claim 20, wherein the cash register system (1) is configured to verify the data transmitted by the mobile telecommunications terminal (5) in case of failure of the data transmission to the payment processing center, wherein the cash register system (1) comprises processing means configured to compare a stored general payment limit with the desired payment amount and to verify the validity of the transaction code using a check algorithm stored in the cash register system (1), wherein the cash register system further comprises release means for releasing the payment, provided the following conditions are fulfilled: the desired payment amount lies within the general payment limit and the transaction code is valid, wherein the cash register system (1) further comprises a storage for storing the released payment, wherein the storage cooperates with transmission means to pass the payment to the payment processing center (7) either later or immediately for initiating a debiting order.

22. A device according to claim 20, wherein the payment processing center (7) is connected to a banking network, wherein the payment processing center is configured to transmit the subscriber identifier and the payment amount to the banking network in the context of a debiting order.

23. A device according to claim 22, wherein personal account numbers and subscriber identifiers are stored, assigned to one another, in the banking network or an interface between the banking network and the payment processing center (7), and the banking network is configured to assign the subscriber identifier transmitted by the payment processing center (7) to the corresponding personal account number, and an account is debited using the personal account number, the respective credit entry in the account of the payment recipient being preferably performed immediately.

24. A device according to claim 23, wherein the personal account number is a virtual account number, wherein virtual account numbers and real account numbers are stored in the banking network assigned to one another and the virtual account number is assignable to the corresponding real account number in the context of a debiting order.

25. A device according to claim 20, wherein the transaction code is an optoelectronically readable code, in particular a bar code, which is displayed on a display unit of the mobile telecommunications terminal (5).

26. A device according to claim 21, wherein the check algorithm and the algorithm used for generating the transaction code are tuned to each other.

27. A device according to claim 20, wherein the payment processing center (7) comprises a storage for the algorithm used for generating the transaction code.

28. A device according to claim 20, wherein the subscriber identifier is a device-specific identifier.

29. A device according to claim 20, wherein the payment processing center (7) comprises matching means cooperating with a banking network to match the payment limit assigned to a subscriber identifier in the payment processing center (7) with a stored payment limit assigned to the respective subscriber identifier in the banking network.

30. A device according to claim 29, wherein the matching means are configured with a trigger circuit to trigger the transmission of a payment limit changed after a matching procedure, wherein no new transaction code is transmitted to the telecommunications terminal and existing transaction codes are deleted from the telecommunications terminal if the payment limit assigned to the subscriber identifier is zero.

31. A device according to claim 20, wherein a program application (6) to be executed on the mobile telecommunications terminal (5) is provided.

32. A device according to claim 31, wherein the subscriber identifier is an application-specific identifier stored in the program application (6).

33. A device according to claim 31, wherein the application comprises a PIN request to request a PIN prior to opening the transaction code, the display or transmission being only effected on correct PIN entry.
